(19) United States
(12) Patent Application Publication
(10) Pub. No.: US 2026/0211419 A1
(43) Pub. Date: Jul. 23, 2026

(54) ROBOT FORMATION PATH PLANNING METHOD AND RELATED DEVICE

(71) Applicant: Chengdu University of Technology, Chengdu (CN)

(72) Inventors: Mingjie Tao, Chengdu (CN); Wenshuo Yuan, Chengdu (CN); Binbin Zhao, Chengdu (CN); Donghao Hu, Chengdu (CN); Jiaxin Wang, Chengdu (CN)

(21) Appl. No.: 19/457,048

(22) Filed: Jan. 22, 2026

(30) Foreign Application Priority Data
Jan. 23, 2025 (CN) 202510110909.0

(51) Int. Cl. G05D 1/246; G05D 1/644; G05D 1/695

(52) U.S. Cl. CPC G05D 1/2464; G05D 1/644; G05D 1/695

(57) ABSTRACT

A robot formation path planning method includes the steps of: selecting a leader robot and expanding obstacles within a two-dimensional (2D) grid map based on positions of follower robots participating in the formation relative to the leader robot, with expanded portions corresponding to feasible positions of the follower robots participating in the formation, and defining feasible grids within the map as a feasible region for the leader robot; generating a suboptimal path for the leader robot using an ant colony optimization (ACO) algorithm through multiple iterations; optimizing the suboptimal path by sequentially applying three strategies: redundant grid deletion, triangle pruning, and polyline smoothing, to obtain an optimal path plan for the leader robot; and removing the previously expanded portions of the obstacles to obtain a complete path planning for the entire robot formation.

### CROSS-REFERENCE TO RELATED APPLICATION

This application claims priority of Chinese Patent Application No. 202510110909.0, filed on Jan. 23, 2025, the entire contents of which are incorporated herein by reference.

### TECHNICAL FIELD

The present disclosure relates to the technical field of robot path planning, and more particularly to a robot formation path planning method and a related device.

### BACKGROUND

In recent years, robot formation technology, particularly in the field of mobile robotics, has become a major research focus. The growing application of intelligent robots in fields such as logistics, the military, and environmental monitoring has made research into robot formation particularly important. Each robot in the formation needs to achieve autonomous navigation in a dynamic environment while ensuring formation stability and path optimality. As a pivotal challenge in robot formation technology, path planning is crucial for the efficient and safe completion of formation tasks.

Robot formation path planning technology refers to the collaborative process through which multiple robots, based on the mutual relative positions and environmental perception information, jointly plan an effective and safe path while working in coordination. Path planning technology requires robots to be capable of avoiding obstacles to optimize the overall motion trajectory and reduce energy consumption. It holds significant application and importance in fields such as autonomous vehicles and unmanned aerial vehicle (UAV) swarms.

Multi-robot formation path planning technologies can be classified into five types: graph-based path planning methods, optimization-based path planning methods, swarm behavior-based path planning methods, game theory-based path planning methods, and adaptive path planning methods. Currently, one of the most widely used path planning methods is the graph-based method. This method constructs a graph model to represent the environment and achieves path planning by computing the shortest paths between robots. Common graph algorithms include several classic shortest-path computation techniques, which can identify efficient paths for individual robots and are suitable for task planning in static environments. However, graph-based methods may involve high computational complexity. Especially in large-scale environments, the real-time performance of path planning can be compromised. When the number of nodes is substantial, the computational overhead increases significantly, adversely affecting path planning efficiency. Optimization-based path planning methods operate by constructing an optimization model and employing mathematical techniques to solve for optimal robot paths. Such methods are typically capable of optimizing paths according to the global objectives of a multi-robot system, such as minimizing total path cost or energy consumption. Common optimization algorithms include genetic algorithms, particle swarm optimization (PSO), and ant colony optimization (ACO). Optimization-based approaches demonstrate powerful performance in multi-robot collaboration, achieving effective global path optimization. However, the computational overhead of such methods is considerable. Especially with a large number of robots, the solution process can become highly complex. Furthermore, adaptability to dynamic environments is often limited, necessitating cautious application in tasks with high real-time requirements. Swarm behavior-based path planning methods simulate collective behaviors observed in nature, such as the Boids model, ACO algorithm, and PSO, among others. By emulating cooperation and information sharing among robots, these approaches can effectively resolve path planning challenges in multi-robot systems. Such methods exhibit strong adaptability for multi-robot collaborative tasks and respond flexibly to dynamic environments. However, in complex settings, swarm-based techniques may encounter issues like slower path convergence and a tendency to fall into local optima. This limitation becomes particularly evident during intricate tasks or in highly uncertain environments, where discovering an optimal path swiftly proves difficult, often requiring extended periods for exploration and adjustment. Game-theoretic path planning methods treat each robot as an independent intelligent agent. Each robot determines its own path selections through game-theoretic interactions. These approaches can optimize the overall performance of a multi-robot system by simulating the interactions among the robots. The Nash equilibrium, a widely applied concept in game theory, is utilized within such models to optimize path planning, ensuring each robot selects an optimal strategy given the environment. Although this method is suitable for tasks with game-theoretic characteristics, such as collision avoidance or resource allocation problems, a limitation lies in the potential for the gaming process to result in less efficient collaboration within the multi-robot system, particularly in complex and dynamically changing environments. Game-theoretic methods require substantial computational resources to handle the gaming decisions of multiple robots. Furthermore, in dynamic settings, the path planning efficiency may be impacted by the inherent constraints of gaming strategies. Adaptive path planning methods emphasize the robot's ability to make real-time adjustments based on environmental changes, enabling adaptation to dynamic obstacles and unknown settings. Common adaptive approaches include the extended Kalman filter and reinforcement learning. Through real-time perception and feedback control, a robot can continuously optimize its path selection during task execution. This type of method is suitable for complex and dynamic scenarios, providing effective path adjustment strategies when robots face uncertain environments. However, adaptive methods may face challenges such as relatively lower path planning accuracy and substantial computational resource consumption. This issue is particularly pronounced in multi-robot collaboration, which requires coordinating large volumes of real-time information. Furthermore, incomplete models and high environmental complexity can negatively impact performance, potentially resulting in suboptimal path planning outcomes.

### SUMMARY

To solve the problems raised in the above background, an objective of the present disclosure is to provide a robot formation path planning method.

To realize the above objective, the present disclosure provides the following technical solution:
a robot formation path planning method includes the steps of:
constructing a grid map and expanding obstacles and boundaries within the grid map;
determining an initial pheromone matrix and an initial potential field heuristic function for the grid map;
selecting each moving node via a roulette wheel strategy by ants based on the initial pheromone matrix and the initial potential field heuristic function to generate ant crawling paths and corresponding path lengths, from which a preliminary path plan is obtained; and
optimizing the preliminary path plan, and removing the expanded obstacles and boundaries to obtain a robot formation path.

Preferably, the expanding obstacles and boundaries within the grid map includes the steps of:
determining a positional relationship between a leader robot and follower robots participating in the formation based on a start point of the leader robot on the grid map; computing inverse vectors of displacement vectors from the leader robot to the follower robots; and expanding the obstacles and boundaries based on the inverse vectors.

Preferably, the determining an initial pheromone matrix and an initial potential field heuristic function for the grid map includes the steps of:
converting the grid map into a distance matrix between adjacent grids;
describing connection relationships and distances between grids according to the distance matrix; obtaining an initial pheromone matrix based on the connection relationships and distances between grids; and determining an initial potential field heuristic function according to the distances between grids.

Preferably, the initial potential field heuristic function is obtained by the following formulas:

$$f a = σ ‖ A - {A}_{a i m} ‖ \\ η = \frac{0 . {5}^{fa}}{‖ A - {A}_{a i m} ‖}$$

where A and Aₐᵢₘ are coordinates of adjacent grids, σ is a potential field constant, and η is the potential field heuristic function.

Preferably, the selecting each moving node via a roulette wheel strategy to generate ant crawling paths and corresponding path lengths includes the steps of:
selecting a next moving node via a roulette wheel strategy by an ant;
determining whether the selected next moving node leads into a dead end; backtracking to the previous node if a dead end is encountered, placing the current grid into a tabu list, and reselecting a new moving node based on the roulette wheel strategy; proceeding directly to select the new moving node via the roulette wheel strategy without returning to the previous grid if no dead end is encountered, updating local pheromones along the path traversed by the ant, and continuing advancement until a destination is reached; and
repeating the above steps, recording the crawling path and the corresponding path length of every ant in each generation, updating a global optimal path, and obtaining a preliminary path plan.

Preferably, the optimizing the preliminary path plan includes the steps of:
optimizing the preliminary path plan by sequentially applying three strategies: redundant grid deletion, triangle pruning, and polyline smoothing.

Preferably, the redundant grid deletion includes the steps of: identifying consecutive path nodes N₁, N₂ . . . . Nₙ, where Nₙ is a neighbor grid of N₁; and deleting nodes N₂N₃ . . . . Nₙ₋₁ from an original continuous path if |N₁Nₙ|≤|N₁N₂|+|N₂N₃|+ . . . +|Nₙ₋₁Nₙ|, and forming a new continuous path segment N₁Nₙ;
the triangle pruning includes the steps of: replacing a polyline segment between consecutive nodes with a straight-line segment connecting any two of these nodes if multiple consecutive nodes in a path form a polyline, and a direct straight-line connection between any two of these nodes is obstacle-free; and
the polyline smoothing includes the steps of: selecting a node and determining whether the node is an inflection point of a polyline segment; replacing the polyline with a curve if so; and proceeding to a next inflection point until a path end is reached if not.

A robot formation path planning system includes:
a construction module, configured to construct a grid map and expand obstacles and boundaries within the grid map;
an initialization module, configured to determine an initial pheromone matrix and an initial potential field heuristic function for the grid map;
a preliminary planning module, configured to select each moving node via a roulette wheel strategy by ants based on the initial pheromone matrix and the initial potential field heuristic function to generate ant crawling paths and corresponding path lengths, from which a preliminary path plan is obtained; and
a formation path acquisition module, configured to optimize the preliminary path plan and remove the expanded obstacles and boundaries to obtain a robot formation path.

A computer device includes a memory, a processor, and a computer program stored in the memory and running on the processor, which, when executing the computer program, implements the steps of the robot formation path planning method.

A computer-readable storage medium includes a computer program stored thereon, which, when executed by a processor, implements the steps of the robot formation path planning method.

Compared with the related art, the present disclosure provides the following beneficial effects. A robot formation path planning method is provided. The method operates on a two-dimensional (2D) grid map by constructing a grid map and expanding obstacles and boundaries within the grid map, thereby defining feasible grids as a feasible region for a leader robot. A suboptimal path is obtained through multiple iterations of an ACO algorithm, resulting in a preliminary path plan. The preliminary path is optimized to obtain an optimal path plan for the leader robot. The previously expanded portions of the obstacles are removed to obtain a complete path planning for the entire robot formation. By adopting a grid map for path planning, the method fully leverages the advantages of grid maps in environmental modeling. The grid map is capable of decomposing a complex environment into discrete grids, transforming the path planning problem into a graph search problem, thereby achieving efficient path coordination and collaboration among multiple robots. Characterized by visualization and discretization, the grid map provides a clear representation of the environment, which enhances the accuracy and reliability of the resulting path plan.

Furthermore, the obstacle expansion technique effectively prevents collisions between robots and obstacles. By appropriately expanding obstacle areas, the method ensures that path planning not only avoids individual obstacles but also adapts to various dynamic environmental changes. This approach significantly enhances the safety of path planning and the stability of the robot formation, guarantees the feasibility of the formation in dynamic environments, and reduces collision risks in complex settings.

Furthermore, by employing a three-step geometric optimization process instead of directly applying polyline smoothing, the computational complexity is significantly reduced. Traditional polyline smoothing methods tend to incur high computational overhead and complexity. In contrast, the present disclosure simplifies the computational process by optimizing the geometric shape of the path, thereby improving algorithm execution efficiency. This approach can effectively reduce the computational burden, especially during large-scale calculations.

Furthermore, the path generated by the present disclosure is a smooth curve, which can effectively mitigate sudden steering issues during robot motion. Compared to polyline paths, the curved path is more natural and continuous, thereby enhancing the robot's motion stability. Especially in scenarios that require continuous and smooth traversal, the curved path can significantly improve the comfort and precision of robot movement, avoiding efficiency losses or trajectory deviations caused by overly abrupt steering maneuvers.

### BRIEF DESCRIPTION OF THE DRAWINGS

FIG. 1 is a flowchart of a robot formation path planning method according to the present disclosure.

FIG. 2 is a flowchart of obstacle expansion according to the present disclosure.

FIG. 3 is a flowchart of an ACO algorithm according to the present disclosure.

FIG. 4 is a flowchart of geometric optimization according to the present disclosure.

FIG. 5 is an original grid map with obstacles according to an embodiment of the present disclosure.

FIG. 6 is a grid map with expanded obstacle contours according to an embodiment of the present disclosure.

FIG. 7 is a robot formation path after applying the ACO algorithm according to an embodiment of the present disclosure.

FIG. 8 is a robot formation path after redundant grid deletion according to an embodiment of the present disclosure.

FIG. 9 is a robot formation path after triangle pruning according to an embodiment of the present disclosure.

FIG. 10 is a robot formation path after polyline smoothing according to an embodiment of the present disclosure.

FIG. 11 is a complete path for a diagonal formation according to an embodiment of the present disclosure.

FIG. 12 is a block diagram of a robot formation path planning system according to the present disclosure.

### DETAILED DESCRIPTION

For clarity of the objectives, technical solutions, and advantages of the embodiments of the present disclosure, the technical solutions in the embodiments of the present disclosure are further described clearly and completely below with reference to the accompanying drawings. Obviously, the embodiments described are only some, rather than all embodiments of the present disclosure. Components of the embodiments depicted and described in the accompanying drawings herein may be arranged and designed in multiple configurations.

Therefore, the detailed description of the embodiments of the present disclosure provided in the accompanying drawings is not intended to limit the scope of the claimed disclosure, but is merely representative of selected embodiments of the present disclosure. Based on the embodiments of the present disclosure, all other embodiments obtained by those ordinary skilled in the art without creative efforts fall within the scope of protection of the present disclosure.

It is to be noted that similar reference numbers and letters in the accompanying drawings denote similar items. Accordingly, once an item is defined with reference to one drawing, it may not be discussed again for subsequent drawings.

To facilitate a better understanding of the technical solutions of the present disclosure by those skilled in the art, the present disclosure is further described in detail below with reference to the accompanying drawings.

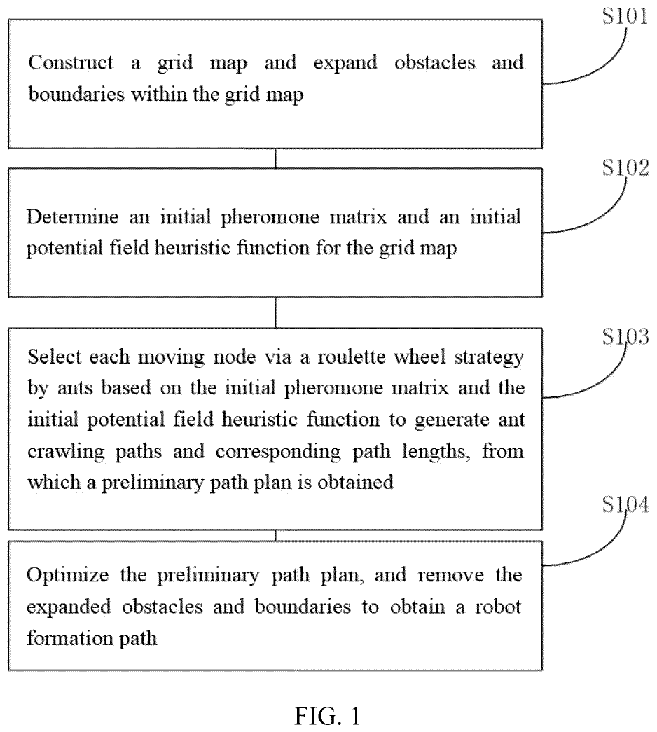

As shown in FIG. 1, the present disclosure provides a robot formation path planning method, including the following steps:
In S101, a grid map is constructed, and obstacles and boundaries within the grid map are expanded.
In S102, an initial pheromone matrix and an initial potential field heuristic function for the grid map are determined.
In S103, ants select each moving node via a roulette wheel strategy based on the initial pheromone matrix and the initial potential field heuristic function to generate ant crawling paths and corresponding path lengths, from which a preliminary path plan is obtained.
In S104, the preliminary path plan is optimized, and the expanded obstacles and boundaries are removed to obtain a robot formation path.

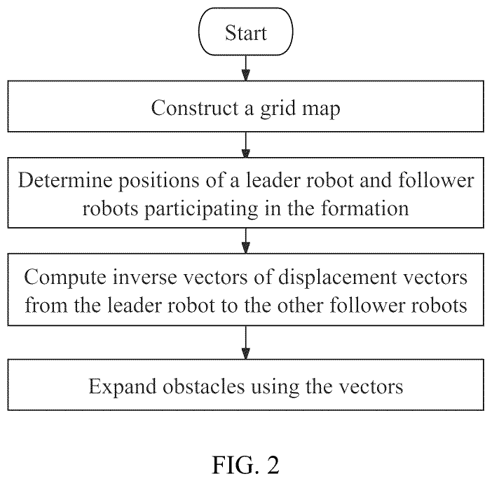

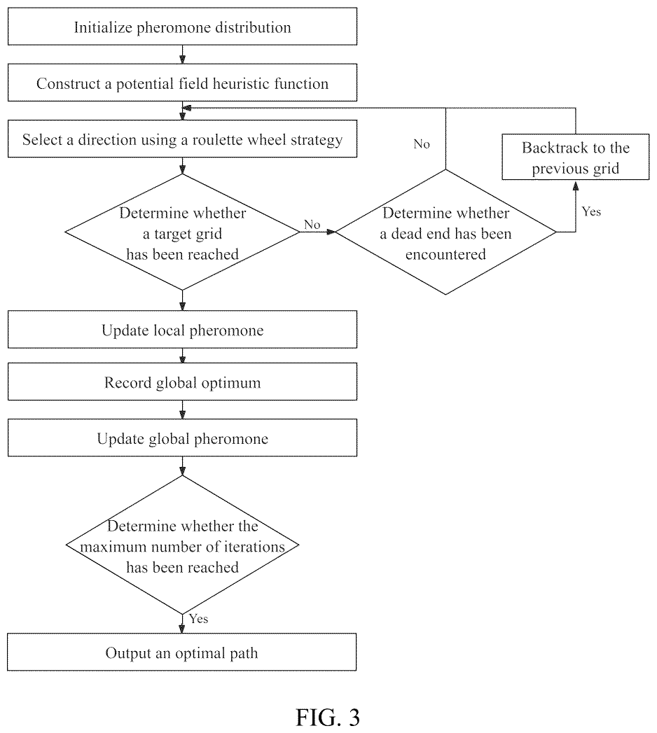

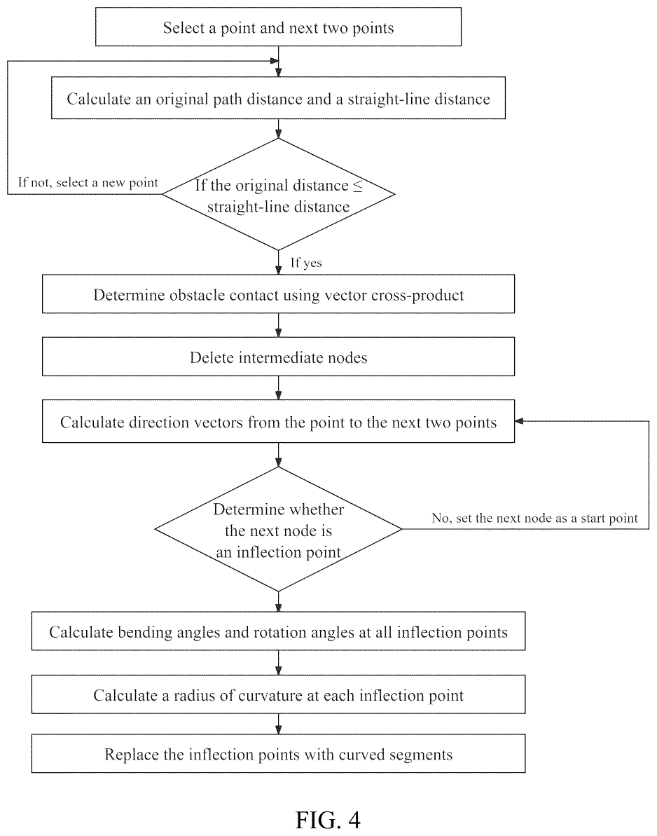

The detailed steps are as follows.
In step 1: construction of a grid map
In step 1.1, the map is partitioned into a plurality of grids to achieve discretization. A unique identifier and coordinates are assigned to each grid to facilitate subsequent path planning.
In step 1.2, the boundary dimensions of the grid map are determined, and the number of rows and columns is calculated. A uniform size is maintained for each grid to ensure consistency in path computation.
In step 1.3, a unique identifier is computed for each grid node according to a linear order, ensuring that each grid node is assigned a distinct identifier to facilitate subsequent path calculation and comparison.
In step 2: determination of obstacles and boundaries (as shown in FIG. 2)
In step 2.1, based on the start point position, distances in the horizontal and vertical directions are calculated, and the required boundary extension length is determined to ensure that obstacle expansion does not interfere with path planning.
In step 2.2, the first robot is designated as a leader robot. Corresponding obstacles and boundaries are added based on the inverse vectors of the relative positions of the follower robots in the formation, thereby ensuring that path planning is required to focus solely on the position of the leader robot.
In step 3: initialization of pheromone matrix and heuristic function (as shown in FIG. 3)
In step 3.1, the map is converted into a distance matrix between adjacent grids, describing the connection relationships and distances between grids to facilitate subsequent path selection.
In step 3.2, the pheromone matrix is initialized to ensure the feasibility of path planning. Pheromones guide ant selection during the path search process.
In step 3.3, the potential field heuristic function is initialized to provide heuristic information for ant path selection, aiding in a more effective search for the shortest path.
In step 4: ant path selection and update
In step 4.1, based on the current pheromone concentration and heuristic information, the next grid to be moved is selected by an ant via a roulette wheel method. This strategy biases the selection toward paths with higher pheromone concentration or more favorable heuristic information, thereby increasing the probability of finding an optimal path.
In step 4.2, the ant's state is updated, and its path is recorded to ensure planning accuracy and feasibility. With each move, the ant's path is updated, and the newly entered grid is placed into a tabu list. The tabu list is configured to prevent the revisiting of already explored grids, reduce redundancy in path selection, and enhance search diversity.
In step 4.3, A check is performed to determine whether the ant has entered a dead end. If a dead end is encountered, a return is made to the previous step for path reselection; otherwise, progression along the current path continues.
In step 5: dead-end determination and path update
In step 5.1, a determination is made as to whether the ant has entered a dead end. If a dead end is encountered (i.e., no feasible path exists for further progress), the ant backtracks to the previous grid, reselects a path, and returns to Step 4 to continue path selection. This mechanism prevents the ant from being trapped in an infeasible path, allowing for continued exploration of other viable options.
In step 5.2, if no dead end is encountered, local pheromones along the path traversed by the ant are updated, and the ant proceeds toward a target grid until a destination is reached. Each time a path segment is traversed, pheromone is added to each corresponding grid as a path segment is traversed, influencing other ants' path selection, increasing global pheromone concentration, and facilitating optimal path search
In step 6: update of a global pheromone matrix
In step 6.1, after all ants have reached the target grid, the global pheromone matrix is updated to include pheromone evaporation and addition of newly deposited pheromone. The updated global pheromone matrix serves as the foundation for the next round of path selection. The pheromone evaporation mechanism ensures that pheromone concentrations on infrequently selected paths gradually diminish, thereby helping to avoid entrapment in locally optimal solutions.
In step 7: iteration and optimal path update (as shown in FIG. 4)
In step 7.1, steps 4 through 6 are repeated, and the path and path length of each ant in every generation are recorded. After each iteration, the global optimal path is updated to seek the shortest and most optimal route. The optimal path from each generation is saved for comparison and further refinement until the algorithm's convergence criteria are met or the maximum number of iterations is reached.
In step 7.2, the feasibility of the path planning is ensured by continuously updating the global optimal route, ultimately determining the shortest path. Through multiple iterations, the algorithm progressively improves the accuracy of the path planning and reduces redundant segments of the path, thereby obtaining a final path that is shortest and feasible.
In step 8: path geometric optimization
In step 8.1, upon completion of all iterations, a preliminary suboptimal path result is output, including the shortest path distance, path identification (ID), and path coordinates. This path is obtained through the ACO algorithm but can be further refined via geometric optimization to improve its quality and computational efficiency.
In step 8.2, geometric optimization is performed on the algorithm-generated path by removing redundant grids and smoothing the path. The objective of this stage is to make the path smoother and less susceptible to obstacles.
In step 8.3, triangle pruning and polyline smoothing techniques are applied to further optimize the path, reducing redundant points and enhancing path feasibility and execution efficiency. These processes involve calculating the path's curvature and performing corresponding optimizations to ensure the final path is as concise and smooth as possible.
In step 8.4, in the presence of obstacles, the cross-product vertical component between the obstacle and the vector from the path's start point along its direction is calculated. If the component is exclusively positive or exclusively negative, the obstacle does not interfere with the path, allowing the current node to be deleted and proceeding to step 8.5. If the component contains both positive and negative values, the path is affected by the obstacle, the node is retained, and the process skips to the next node.
In step 8.5, a determination is made as to whether the node is a polyline inflection point. All inflection points are recorded, and the angles at all inflection points are calculated. The angular information at inflection points aids in subsequent smoothing processes, preventing overly sharp turns in the path.
In step 8.6, a reasonable radius is calculated at each inflection point, and the trajectory of the curve is derived based on the angle at the inflection point. Through curve fitting, straight-line segments in the path are reduced, making the overall path smoother and more natural, thereby avoiding unnecessary sharp steering during robot movement.
In step 9: removal of expanded obstacles, and generation of the formation path through plotting of a leader robot's route and addition of routes of the other follower robots
In step 9.1, the expanded obstacles are removed to eliminate potential interference factors introduced during path planning. The geometrically optimized path provides a more efficient and safer travel route for the leader robot and the other follower robots.
In step 9.2, the leader robot's route is plotted. Based on this leader robot's route, the routes of the other follower robots are added, ultimately yielding the complete formation path. The paths for all robots are generated with consideration for inter-robot spacing and formation requirements, ensuring the entire robot queue can operate smoothly, avoid collisions, and maintain the formation shape.

By combining the ACO algorithm with geometric optimization, the path planning method of the present disclosure can plan the shortest, safest, and feasible path for the robot formation in a complex environment. By pre-expanding obstacles to circumvent complex terrain and avoid inter-robot collisions, the stability and adaptability of the robot formation are enhanced.

The present disclosure further simplifies the path structure and reduces computational complexity through geometric optimization techniques, ensuring that optimized paths can be efficiently generated in real-time computation. Compared with traditional path planning methods, the path planning method of the present disclosure not only improves the travel efficiency of the robot formation but is also capable of responding to obstacle variations in dynamic environments, possessing a stronger emergency response capability.

Another embodiment of the present disclosure provides a robot formation path planning method, including the following steps:

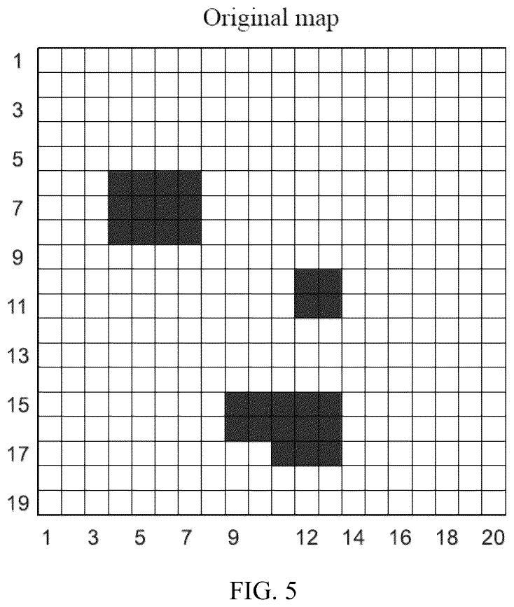

In step 1, a grid map is constructed, as shown in FIG. 5, where black grids represent original obstacles and white grids represent feasible regions.

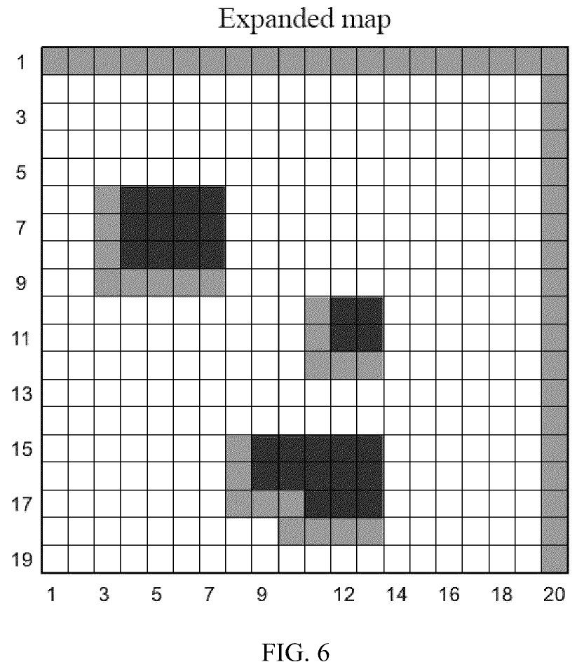

In step 2, based on the position of the leader robot's start point, the horizontal distances SXR and SXL and the vertical distances SYD and SYU are calculated, and the required boundary extension length is determined. With the first robot designated as the leader robot, obstacles and boundary limits are added according to the negative vectors of the relative distances within the formation, as shown in FIG. 6, where gray grids represent the expanded obstacles. This ensures that attention needs to be paid only to the route of the leader robot.

$$SXR = \vert min ( {x}_{0} - x , 0 ) \vert SXL = \vert min ( x - {x}_{0} , 0 ) \vert SYD = \vert min ( y - {y}_{0} , 0 ) \vert SYU = \vert min ( {y}_{0} - y , 0 ) \vert$$

where (x₀, y₀) are horizontal and vertical coordinates of a robot participating in the formation, and (x, y) are horizontal and vertical coordinates of the leader robot.

In step 3, the map is converted into a distance matrix D between adjacent grids to describe connection relationships and distances between grids. Based on the connection relationships and distances between grids, the initial pheromone matrix t is obtained to ensure the feasibility of path planning. According to the distances between grids, the initial potential field heuristic function n is derived to provide heuristic information for path selection.

$$f a = σ ‖ A - {A}_{a i m} ‖ \\ η = \frac{0 . {5}^{fa}}{‖ A - {A}_{a i m} ‖}$$

where A and Aₐᵢₘ are coordinates of adjacent grids, and σ is a potential field constant.

In step 4, based on the initial pheromone matrix t and the initial potential field heuristic function η, the next node to be moved is selected by an ant via a roulette wheel method. The ant's state is updated and its path is recorded to ensure the feasibility of the path planning.

$$P P ( i ) = τ ( i ) \cdot α \cdot η ( i ) \cdot β \\ P = \frac{P P ( i )}{\sum ( P P ( i ) )}$$

where PP represents the probability of moving to a neighboring grid cell.

In step 5, a determination is made as to whether the ant has entered a dead end. If a dead end is encountered, the ant returns to the previous node, the current grid is placed into the tabu list, and the process proceeds to step 4. If no dead end is encountered, the local pheromone t along the path traversed by the ant is updated, and the process continues until the destination is reached.

In step 6, the global pheromone matrix is updated to include pheromone evaporation and addition of newly deposited pheromone.

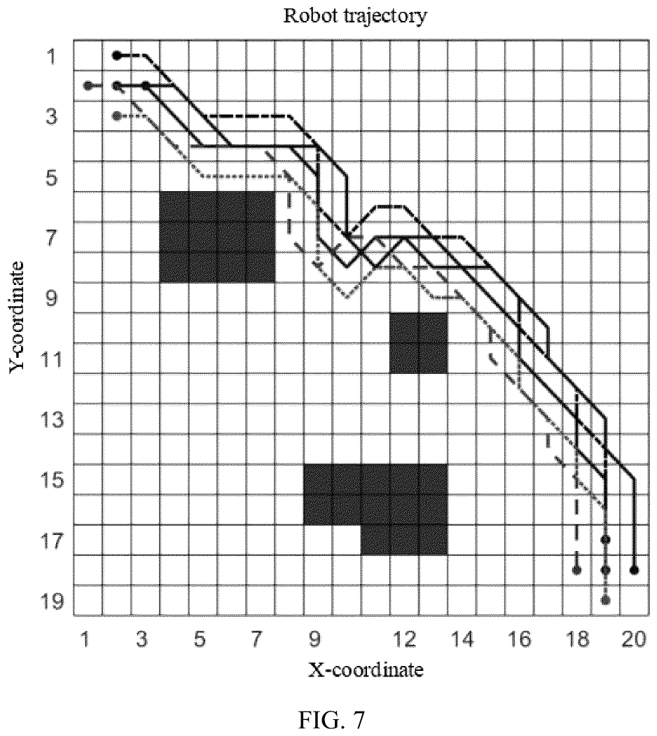

In step 7, steps 4 through 6 are repeated. The crawling path and path length of every ant in each generation are recorded. The global optimal path is updated accordingly, resulting in a preliminary path plan (as shown in FIG. 7).

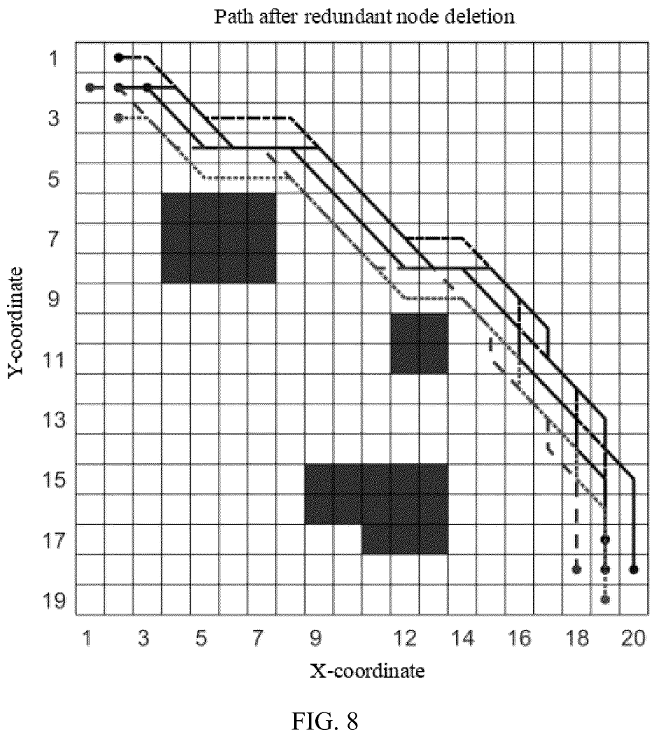

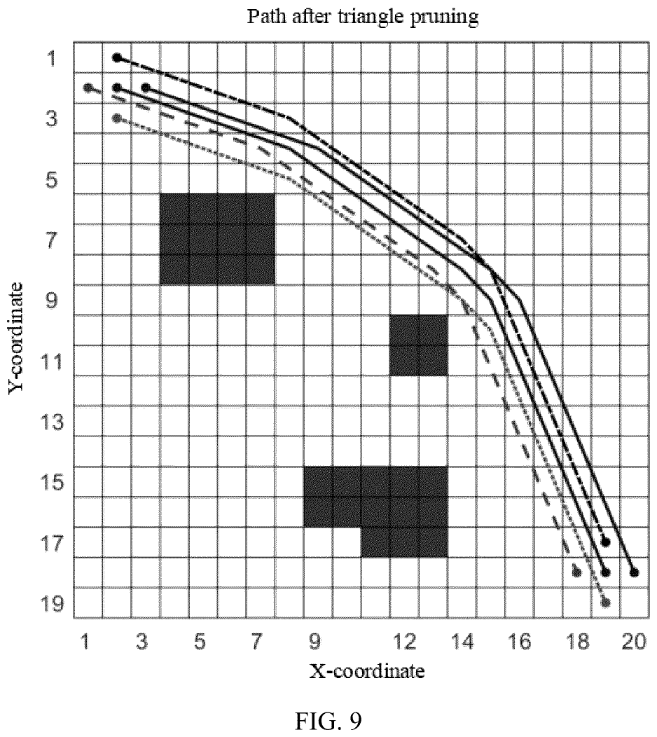

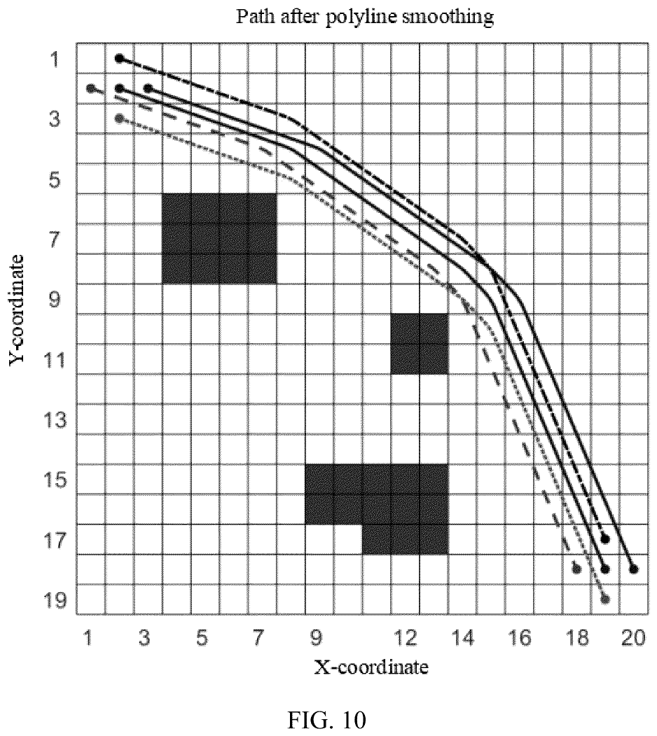

In step 8, geometric path optimization is performed sequentially through the following three steps:
redundant grid deletion: consecutive path nodes N₁, N₂ . . . Nₙ are identified, where Nₙ is a neighbor grid of N₁. If |N₁Nₙ|≤|N₁N₂|+|N₂N₃|+ . . . +|Nₙ₋₁Nₙ|, nodes N₂N₃ . . . . Nₙ₋₁ are deleted from an original continuous path, and a new continuous path segment N₁Nₙ is formed, as shown in FIG. 8;
triangle pruning: if multiple consecutive nodes N₁, N₂ . . . . Nₙ in a path form a polyline segment, and a direct straight-line connection between N₁ and Nₙ is obstacle-free, a polyline segment between N₁, N₂ . . . Nₙ is replaced with a straight-line segment connecting N₁ and Nₙ. The effect is shown in FIG. 9; and
polyline smoothing: a node is selected and it is determined whether the node is an inflection point of a polyline segment. If so, the polyline segment is replaced with a curve; otherwise, the process proceeds to the next inflection point until the destination is reached. The effect is shown in FIG. 10.

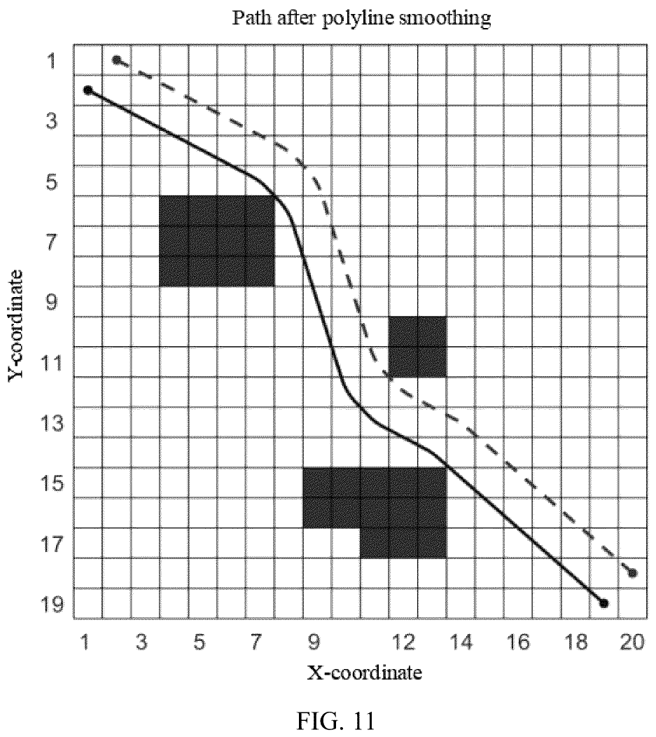

In step 9, the expanded obstacles are removed, the path of the leader robot is plotted, and the paths of the other follower robots are added and plotted, resulting in the complete formation path, with the effect shown in FIG. 11.

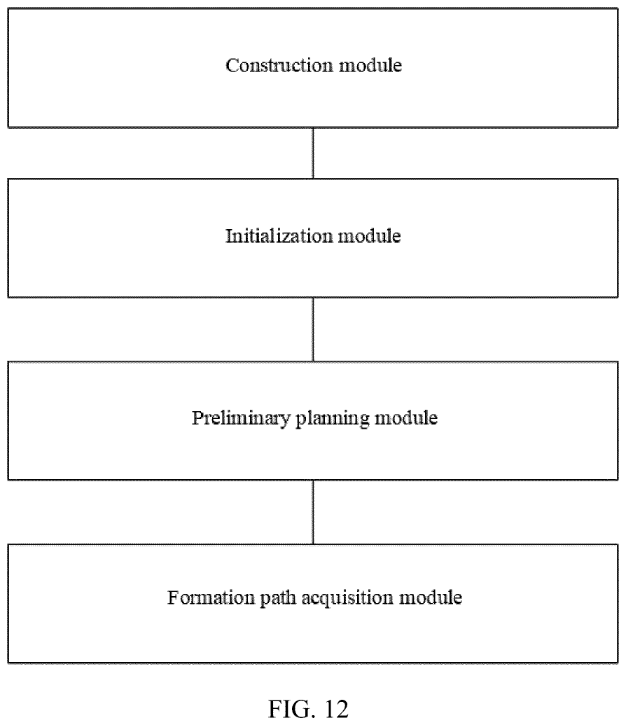

As shown in FIG. 12, the present disclosure provides a robot formation path planning system, including:
a construction module, configured to construct a grid map and expand obstacles and boundaries within the grid map;
an initialization module, configured to determine an initial pheromone matrix and an initial potential field heuristic function for the grid map;
a preliminary planning module, configured to select each moving node via a roulette wheel strategy by ants based on the initial pheromone matrix and the initial potential field heuristic function to generate ant crawling paths and corresponding path lengths, from which a preliminary path plan is obtained; and
a formation path acquisition module, configured to optimize the preliminary path plan and remove the expanded obstacles and boundaries to obtain a robot formation path.

A further embodiment of the present disclosure provides a terminal device. The terminal device of this embodiment includes: a processor, a memory, and a computer program stored in the memory and executable on the processor. The processor, when executing the computer program, implements the steps in the various method embodiments described above. Alternatively, the processor, when executing the computer program, implements the functions of the modules/units in the various apparatus embodiments described above.

The computer program may be split into one or more modules/units, which are stored in the memory and executed by the processor to accomplish the present disclosure.

The terminal device may be a computing device such as a desktop computer, a notebook, a handheld computer, or a cloud server. The terminal device may include, but is not limited to, a processor and a memory.

The processor may be a central processing unit (CPU), or may be another general-purpose processor, a digital signal processor (DSP), an application specific integrated circuit (ASIC), a field-programmable gate array (FPGA), or other programmable logic device, discrete gate or transistor logic device, discrete hardware component, or the like.

The memory is configured to store the computer program and/or modules. The processor implements the various functions of the terminal device by executing the computer program and/or modules stored in the memory and by accessing data stored therein.

If the integrated modules/units of the terminal device are implemented as software functional units and sold or used as independent products, the modules/units may be stored in a computer-readable storage medium. Based on this concept, all or part of the processes in the method embodiments described above may also be implemented by a computer program instructing relevant hardware. The computer program may be stored in a computer-readable storage medium. When executed by a processor, the computer program can implement the steps of the various method embodiments. The computer program includes computer program code, which may take the form of source code, object code, an executable file, or certain intermediate forms. The computer-readable medium may include, but is not limited to, any entity or device capable of carrying the computer program code, a recording medium, a universal serial bus (USB) flash drive, a removable hard disk, a magnetic disk, an optical disc, a computer memory, a read-only memory (ROM), a random access memory (RAM), an electrical carrier signal, a telecommunications signal, and a software distribution medium. It is to be noted that the content encompassed by the computer-readable medium may be subject to appropriate additions or reductions according to the requirements of legislation and patent practice within a given jurisdiction. For instance, in certain jurisdictions, under local legislation and patent practice, computer-readable media may exclude electrical carrier signals and telecommunications signals.

While the embodiments of the present disclosure have been described above with reference to the accompanying drawings, the present disclosure is not limited to the specific implementations and application fields described. The specific implementations provided are merely illustrative and exemplary, not restrictive. Under the guidance of this specification and without departing from the scope protected by the claims of the present disclosure, those of ordinary skill in the art may devise various other forms and modifications, all of which fall within the scope of protection of the present disclosure.

1. A robot formation path planning method, comprising the steps of:
constructing a grid map and expanding obstacles and boundaries within the grid map;
determining an initial pheromone matrix and an initial potential field heuristic function for the grid map;
selecting each moving node via a roulette wheel strategy by ants based on the initial pheromone matrix and the initial potential field heuristic function to generate ant crawling paths and corresponding path lengths, from which a preliminary path plan is obtained; and
optimizing the preliminary path plan, and removing the expanded obstacles and boundaries to obtain a robot formation path;
the expanding obstacles and boundaries within the grid map comprising the steps of:
determining a positional relationship between a leader robot and follower robots participating in the formation based on a start point of the leader robot on the grid map; calculating distances in horizontal and vertical directions, and determining a length of boundaries to be added; computing inverse vectors of displacement vectors from the leader robot to the follower robots; and adding corresponding obstacles and boundaries based on the inverse vectors; and
the selecting each moving node via a roulette wheel strategy by ants based on the initial pheromone matrix and the initial potential field heuristic function to generate ant crawling paths and corresponding path lengths comprising the steps of:
selecting a next grid to be moved via a roulette wheel strategy by an ant based on current pheromone concentration and heuristic information, wherein the roulette wheel strategy is capable of biasing selection toward paths with higher pheromone concentration or more favorable heuristic information, increasing probability of finding an optimal path;
updating an ant's state and recording a path thereof to ensure accuracy and feasibility of path planning, comprising updating the path with each move while placing a newly entered grid into a tabu list, wherein the tabu list is configured to prevent revisiting of already explored grids, reduce redundancy in path selection, and enhance path search diversity;
performing a check to determine whether the ant has entered a dead end; returning to the previous step for path reselection if a dead end is encountered; otherwise, proceeding along the path;
determining whether the ant has entered a dead end; and backtracking to the previous grid and reselecting a path to continue path selection if a dead end is encountered, wherein a backtracking mechanism is configured to prevent the ant from being trapped in an infeasible path, allowing for continued exploration of other viable paths;
updating local pheromone along the path traversed by the ant if no dead end is encountered, and proceeding toward a target grid until a destination is reached, wherein each time a path segment is traversed, pheromone is added to corresponding grids to influence other ants' path selection and increase global pheromone concentration, facilitating optimal path search; and
updating a global pheromone matrix after all ants reach the target grid, the updating comprising pheromone evaporation and addition of newly deposited pheromone to provide a foundation for a next selection round, wherein a pheromone evaporation mechanism is configured to ensure that pheromone concentrations on infrequently selected paths gradually diminish, avoiding entrapment in locally optimal solutions.

2. The robot formation path planning method according to claim 1, wherein the determining an initial pheromone matrix and an initial potential field heuristic function for the grid map comprises the steps of:
converting the grid map into a distance matrix between adjacent grids; describing connection relationships and distances between grids according to the distance matrix; obtaining an initial pheromone matrix based on the connection relationships and distances between grids; and determining an initial potential field heuristic function according to the distances between grids.

3. The robot formation path planning method according to claim 2, wherein the initial potential field heuristic function is obtained by the following formulas:
$$f a = σ ‖ A - {A}_{a i m} ‖ \\ η = \frac{0 . {5}^{fa}}{‖ A - {A}_{a i m} ‖}$$
where A and Aₐᵢₘ are coordinates of adjacent grids, σ is a potential field constant, and η is the potential field heuristic function.

4. The robot formation path planning method according to claim 1, wherein the optimizing the preliminary path plan comprises the steps of:
optimizing the preliminary path plan by sequentially applying three strategies:
redundant grid deletion, triangle pruning, and polyline smoothing.

5. The robot formation path planning method according to claim 4, wherein
the redundant grid deletion comprises the steps of: identifying consecutive path nodes N₁, N₂ . . . Nₙ, where Nₙ is a neighbor grid of N₁; and deleting nodes N₂N₃ . . . Nₙ₋₁ from an original continuous path if |N₁Nₙ|≤|N₁N₂|+|N₂N₃|+ . . . +|Nₙ₋₁Nₙ|, and forming a new continuous path segment N₁Nₙ;
the triangle pruning comprises the steps of: replacing a polyline segment between consecutive nodes with a straight-line segment connecting any two of these nodes if multiple consecutive nodes in a path form a polyline, and a direct straight-line connection between any two of these nodes is obstacle-free; and
the polyline smoothing comprises the steps of: selecting a node and determining whether the node is an inflection point of a polyline segment; replacing the polyline with a curve if so; and proceeding to a next inflection point until a destination is reached if not.

6. A robot formation path planning system, comprising:
a construction module, configured to construct a grid map and expand obstacles and boundaries within the grid map;
an initialization module, configured to determine an initial pheromone matrix and an initial potential field heuristic function for the grid map;
a preliminary planning module, configured to select each moving node via a roulette wheel strategy by ants based on the initial pheromone matrix and the initial potential field heuristic function to generate ant crawling paths and corresponding path lengths, from which a preliminary path plan is obtained; and
a formation path acquisition module, configured to optimize the preliminary path plan and remove the expanded obstacles and boundaries to obtain a robot formation path.

7. A computer device, comprising a memory, a processor, and a computer program stored in the memory and running on the processor, which, when executing the computer program, implements the steps of the robot formation path planning method according to claim 1.

8. A computer device, comprising a memory, a processor, and a computer program stored in the memory and running on the processor, which, when executing the computer program, implements the steps of the robot formation path planning method according to claim 2.

9. A computer device, comprising a memory, a processor, and a computer program stored in the memory and running on the processor, which, when executing the computer program, implements the steps of the robot formation path planning method according to claim 3.

10. A computer device, comprising a memory, a processor, and a computer program stored in the memory and running on the processor, which, when executing the computer program, implements the steps of the robot formation path planning method according to claim 4.

11. A computer device, comprising a memory, a processor, and a computer program stored in the memory and running on the processor, which, when executing the computer program, implements the steps of the robot formation path planning method according to claim 5.

12. A computer-readable storage medium, comprising a computer program stored thereon, which, when executed by a processor, implements the steps of the robot formation path planning method according to claim 1.

13. A computer-readable storage medium, comprising a computer program stored thereon, which, when executed by a processor, implements the steps of the robot formation path planning method according to claim 2.

14. A computer-readable storage medium, comprising a computer program stored thereon, which, when executed by a processor, implements the steps of the robot formation path planning method according to claim 3.

15. A computer-readable storage medium, comprising a computer program stored thereon, which, when executed by a processor, implements the steps of the robot formation path planning method according to claim 4.

16. A computer-readable storage medium, comprising a computer program stored thereon, which, when executed by a processor, implements the steps of the robot formation path planning method according to claim 5.
